(19) United States
(12) Patent Application Publication
(10) Pub. No.: US 2023/0348821 A1
(43) Pub. Date: Nov. 2, 2023

(54) PACKAGING FOR PERFUME PARTICLES

(71) Applicant: Conopco, lnc., d/b/a UNILEVER, Englewood Cliffs, NJ (US)

(72) Inventors: Ross David ASHTON, Northwich (GB); Geoffrey Stephen MAWTUS, Ormskirk (GB); Kieran Dean OWENS, Wrexham (GB); Jessica Frances Sophia PEAKE, Leeds (GB); Mark Lee VERHAEGE, Wigan (GB); Christopher Paul WEIR, Kelsall, Tarporley (GB); Glen James WILLIAMS, Liverpool (GB)

(73) Assignee: Conopco, lnc., d/b/a UNILEVER, Englewood Cliffs (GB)

(21) Appl. No.: 18/028,824

(22) PCT Filed: Sep. 15, 2021
(86) PCT No.: PCT/EP2021/075339

§ 371 Date: Mar. 28, 2023

(30) Foreign Application Priority Data
Sep. 30, 2020 (EP) 20199145.2
Sep. 30, 2020 (EP) 20199156.9

(51) Int. Cl. C11D 3/50; C11D 17/00; C11D 11/00

(52) U.S. Cl. CPC C11D 3/505; C11D 17/0039; C11D 11/0017

(57) ABSTRACT

A packaged laundry product comprising packaging and perfume particles contained in said packaging; wherein the packaging comprises a cylindrical receptacle formed from a material comprising cellulosic fibres, wherein the receptacle comprises a mechanism for impeding a child's access to the container; and wherein the perfume particles comprise carrier material and perfume components.

### FIELD OF THE INVENTION

The present invention is in the field of packaging for perfume particle laundry additives.

### BACKGROUND OF THE INVENTION

Perfume particle laundry additives are known. These are solid particles which the consumer can add to the laundry process to enhance the fragrance delivered to the fabric.

EP 2496679 discloses scent additives. The compositions disclosed therein comprise polyethylene glycol, free perfume and perfume microcapsules and optionally a dye.

These products are traditionally packaged in plastic bottles. Bottles allow the consumer to pour solid particles into a dosing cup or straight into the wash and are ergonomically pleasing to use. However, there is an increasing consumer desire for ‘plastic free’ products. The use of cardboard boxes is known for products such as laundry powders, however these have many functional draw backs compared to plastic bottles.

There is a need for a new type of packaging which is functional, safe to use and meets the consumers concerns about the environmental impact of the product. The packaged compositions described herein addresses these needs.

### SUMMARY OF THE INVENTION

In a first aspect of the present invention is provided a packaged laundry product comprising packaging and perfume particles contained in said packaging;
wherein the packaging comprises a cylindrical receptacle formed from a material comprising cellulosic fibres, wherein the receptacle comprises a mechanism for impeding a child's access to the container;
and wherein the perfume particles comprise carrier material and 0.5 to 20 wt. % perfume components.

In a second aspect of the present invention is provided a method of storing perfume particles, wherein perfume particles comprising a carrier and perfume components are contained in packaging comprising a cylindrical receptacle formed from a material comprising cellulosic fibres, wherein the receptacle comprises a mechanism for impeding a child's access to the container.

In a third aspect of the present invention is provided a use of packaging comprising a cylindrical receptacle formed from a material comprising cellulosic fibres, wherein the receptacle comprises a mechanism for impeding a child's access to the container, to contain perfume particles comprising a carrier and perfume components.

### DESCRIPTION OF THE FIGURES

FIG. 1a: Is a perspective view of a circular cylinder

FIG. 1b: Is perspective view of an elliptical cylinder

FIG. 2a: Is a perspective view of a lid on a container

FIG. 2b: Is a perspective view of a rib and notch mechanism

FIG. 2c: Is a perspective view of a rib and notch mechanism

FIG. 3a: Is a perspective view of a lid on a container

FIG. 3b: Is a perspective view of a rib and notch mechanism

FIG. 4a: Is a perspective view of a lid on a container

FIG. 4b: Is a perspective view of a groove and notch mechanism

FIG. 4c: Is a perspective view of a groove and notch mechanism

FIG. 4d: Is a cross section view of a lid with a spring mechanism

FIG. 4e: Is a cross section view of a lid with a spring mechanism on a container

FIG. 5a: Is a perspective view of a closed latch release latch mechanism

FIG. 5b: Is a perspective view of an open latch release mechanism

FIG. 5c: Is a cross section view of a container with a latch

FIG. 6a: Is a perspective view of a closed container with an alignable holes

FIG. 6b: Is a perspective view of an open container with an alignable holes

FIG. 7a: Is a perspective view of a closed container with an alignable holes

FIG. 7b: Is a perspective view of an open container with an alignable holes

FIG. 8a: Is a cross section view of a deformable lid on a container

FIG. 8b: Is a cross section view of a deformable lid removed from a container

FIG. 9: Is a cross section view of an external securing means

FIG. 10a: Is a perspective view of a closed friction fit receptacle

FIG. 10b: Is a perspective view of an open friction fit receptacle

FIG. 11a: Is a perspective view of a closed multi rotation receptacle

FIG. 11b: Is a perspective view of an open multi rotation receptacle

FIG. 12a: Is a perspective view of a closed expandable pack

FIG. 12b: Is a perspective view of an open expandable pack

### DETAILED DESCRIPTION

These and other aspects, features and advantages will become apparent to those of ordinary skill in the art from a reading of the following detailed description and the appended claims. For the avoidance of doubt, any feature of one aspect of the present invention may be utilised in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

The packaged laundry product described herein comprises packaging and perfume particles stored within said packaging. The packaging comprises a receptacle formed from a material comprising cellulosic fibres and child impeding closure. The perfume particles comprise a carrier material and perfume components.

Packaging

The packaging for the perfume particles described herein comprises a receptacle formed from a material comprising cellulosic fibres wherein the receptacle comprises a mechanism for impeding a child's access to the container. The mechanism may alternatively be called a child impeding closure.

The packaging for the perfume particles described herein comprises a receptacle. The receptable preferably comprises a container and a lid. The lid may be separable from the container, i.e. a separate entity which may be entirely removed from the container to access the contents of the container.

The receptable is formed from a material comprising cellulosic fibres. Preferably the receptacle is formed from cardboard (such as paperboard or corrugated fibreboard), paper pulp or other cellulosic fibre materials. More preferably the receptacle is formed from cardboard or paper pulp, most preferably cardboard. The cardboard may for example be a laminate structure, a composite structure, or a corrugated structure. Preferably the receptacle is formed from recycled materials i.e. from cellulosic fibres previously used in industry or by consumers. Paper pulp may be preferable when the receptacle comprises aspects which need to be moulded. It may be the case that the container and the lid of the receptable are made from different materials, for example the container being made from cardboard and the lid from paper pulp.

Preferably the density of the material comprising cellulosic fibres is at least 100 g/m².

When using cardboard, the cardboard may comprise multiple sheets of material. In this case there may be disposed a sheet of corrugated cardboard between the sheets. The receptible may be manufactured in the form of a sheet or blank, which is folded to make a container and lid. In this case preferably the sheet or blank is shaped to form the whole container from one sheet or blank. Most preferably the sheet or blank is weakened (such as by scoring) to aid the folding process. The sheet of blank may include flaps or tabs for aiding the joining of sides of the external skin, and which may not be visible when the external skin has been assembled into its final shape. The flaps or tabs may be fixed in place using an adhesive material.

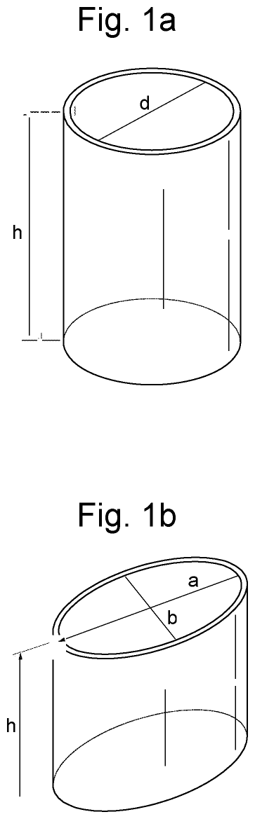

The receptacle of the present invention is cylindrical. This may also be referred to as a cylinder, a tube or a circular prism. The cylinder may have a circular cross section as demonstrated in FIG. 1a or an elliptical cross section as demonstrated in FIG. 1b. Being cylindrical allows ergonomic and controlled pouring of the perfume particles out of the container.

The cylindrical receptacle described herein comprises a mechanism for impeding a child's access to the container or a child impeding closure. A child impeding closure is a mechanism designed to impede a child's access to the contents of the receptacle, thus reducing the chance of accidental ingestion. Although child impeding closures are known for plastic packaging, these are not suitable for a cylindrical receptacle formed from a material comprising cellulosic fibres as described herein. Various non-limiting options for child impeding closures on receptacles formed from a material comprising cellulosic fibres are described herein. These mechanisms include features which require careful manipulation, which require a certain level or force, or which require adult sized hands to operate. Examples of suitable mechanisms are described herein.

a) An Assembly of Corresponding Notches and Ribs or Groves in the Lid and Container

Corresponding notches and ribs or groves in the lid and container require careful manipulation in the form of twisting and lifting the lid to remove the lid from the container to access the perfume particles.

In one embodiment the container comprises a horizontal rib/ribs situated on the external wall of the container and the lid comprises a notch/notches situated on the internal vertical face of the lid. The rib(s) comprise vertical opening sufficiently wide for the notch(es) on the lid to pass through. Each rib must comprise at least as many vertical openings as notch(es) present in the lid. The spacing between the vertical openings in a rib must correspond to the spacing between notch(es) on the lid. When the lid is fitted on the container, the rib(s) prevent vertical movement of the notches pass a certain point. The lid must be rotated relative to the container, until the notch(es) in the lid align with the vertical openings in the rib. Alignment allows the lid to be lifted vertically. Preferably a second layer of rib(s) is present. The lid must once again be rotated relative to the container to allow alignment between the notches and the second layer of ribs. The different layers of ribs may be positioned at any height on the container.

In an alternative embodiment the container comprises a grove(s) and the lid comprises a notch(es) situated on the internal vertical face of the lid. Groves are a channel in the vertical wall of the container. The channel is sufficiently wide for the notch(es) situated on the corresponding lid to pass through. The groves start at the top edge of the container. They may be any suitable shape, requiring the lid to be moved in more than one direction relative to the container, to reach a ‘locked’ position, i.e. the other end on the channel. The channel may be a simple vertical section followed by a horizontal section to reach a ‘locked’ position. Alternatively, the channel may have additional sections, such as additional vertical and horizonal sections of the channel. The channel may include some diagonal sections, for example the channel may from a vertical zig-zag shape. The channel may be cut the whole way through the container wall, or may be cut only partially through the external wall of the container.

For both embodiments described above, the notch(es) may alternatively be situated on the external vertical surface of the container and the rib(s)/grove(s) situated on the internal vertical surface of the lid. The assembly of corresponding features would operate in the same way as descried above. Equally, when the notches are located on the lid, they maybe located on the internal rim as described herein, alternatively then may be located in any other position on the internal vertical wall of the lid. When the notches are located on the external wall of the container, they may be situated in any suitable location.

The lid may be an ‘over-cap’ wherein the vertical wall of the lid sits outside the container alternatively the lid may be an ‘inverted’ cap, wherein the vertical wall of the lid sits inside the container. The assembly of notches and ridges can be implemented with either embodiment.

Preferably the container will have a marking indicating to the consumer that they have reached a ‘locked’ position and the lid is safely attached to the container.

The assembly of corresponding notches and ribs or groves in the lid and container are preferably combined with a spring mechanism, which provides some resistance to the movement required to manipulate the lid relative to the container. The spring mechanism may be removable, in which case it may be made from any suitable material. Alternatively, the spring mechanism may be integral to the lid or container, in which case it is preferably made from a material comprising cellulosic fibres. Examples of spring mechanisms include a spring and a plate, wherein the springs are compressed by force being exerted on the plate. Alternatively, the spring mechanism may be provided by a resilient strip forming an arch in the lid of the receptacle, which must be deformed be the container to reach a locked position. Alternatively, the spring mechanism may be a dome or pocket of air in the lid, which must be deformed be the container to reach a locked position. When a removable sprong mechanism is used, this does not contribute to the overall weight of the receptacle for the purposes of calculating the weight % of perfume barrier material present.

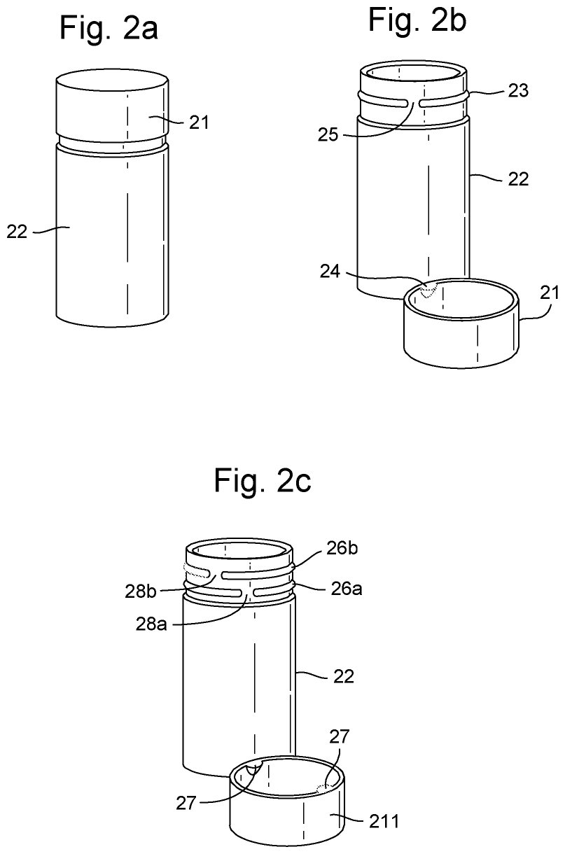

FIGS. 2a and 2b depict one possible embodiment having a rib and notch. FIG. 2a depicts the lid (21) situated on the container (22) in a closed position. FIG. 2b depicts the lid (21) removed from the container (22); the lid (21) is in an inverted position. The lid (21) comprises a notch (24) situated on the internal rim of the lid (21). The container (22) comprises a rib (23) situated on the external vertical wall of the container. The rib (23) has a vertical opening (25). The vertical opening (25) is wide enough for the notch (24) to pass through. From a closed position, the lid (21) must be rotated horizontally relative to the container (22), when the notch (24) aligns with the vertical opening (25) the lid (21) can be lifted vertically off the container (22).

FIG. 2c depicts an alternative embodiment having ribs and notches. The embodiment of FIG. 2c comprises two layers of ribs (26a & 26b) on the external vertical wall of the container and two notches (27) on the internal rim of the lid (211). Each layer of ribs (26a & 26b) comprise two vertical openings (28a & 28b); one vertical opening (28a & 28b) is visible in each layer, the other vertical opening on each layer is situated on the back side of the container (not visible). The two vertical openings (28a & 28b) on each layer of ribs (26a & 26b) are spaced apart corresponding to the spacing of the notches (27). The vertical openings (28a & 28b) on each layer of ribs (26a & 26b) are off set. The vertical opening (28a & 28b) are wide enough for the notches (27) to pass through. From a closed position, the lid (211) must be rotated horizontally relative to the container, until the two notches (27) align with the two vertical openings (28a) of the bottom layer of ribs (26a). The lid can be lifted vertically until the notches (27) abut with the top layer of ribs (26b). The lid must again be rotated horizontally relative to the container, until the two notches (27) align with the two vertical openings (28b) of the top layer of ribs (26b). The lid may then be lifted vertically off the container.

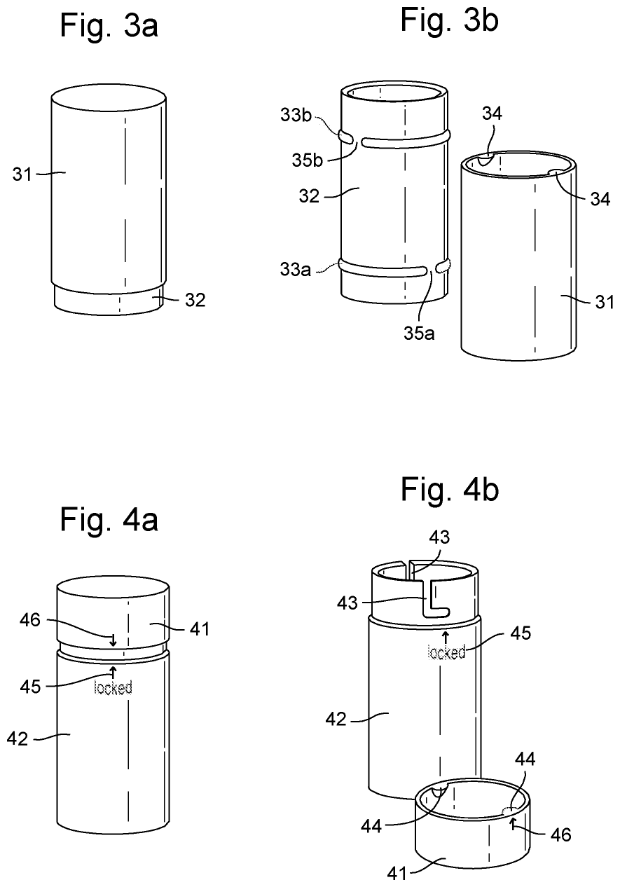

FIGS. 3a and 3b depict an alternative embodiment having ribs and notches. FIG. 3a depicts the lid (31) situated on the container (32) in a closed position. FIG. 3b depicts the lid (31) removed from the container (32); the lid (31) is in an inverted position. The container (31) comprises two layers of ribs (33a & 33b) on the external vertical wall of the container. The lid (31) comprises two notches (34) on the internal rim of the lid (31). Each layer of ribs (33a & 33b) comprise two vertical openings (35a &35b); one vertical opening (35a & 35b) is visible in each layer, the other vertical opening on each layer is situated on the back side of the container (not shown). The two vertical openings (35a & 35b) of each layer of ribs (33a & 33b) are spaced apart corresponding to the spacing of the notches (34). The vertical openings (35a & 35b) on each layer of ribs (33a & 33b) are off set. The vertical opening (35a & 35b) are wide enough for the notches (34) to pass through. From a closed position, the lid must be rotated horizontally relative to the container, until the two notches (34) align with the two vertical openings (35a) of the bottom layer of ribs (33a). The lid can be lifted vertically until the notches (34) abut with the top layer of ribs (33b). The lid must again be rotated horizontally relative to the container, until the two notches (34) align with the two vertical openings (35b) of the top layer of ribs (33b). The lid may then be lifted vertically off the container.

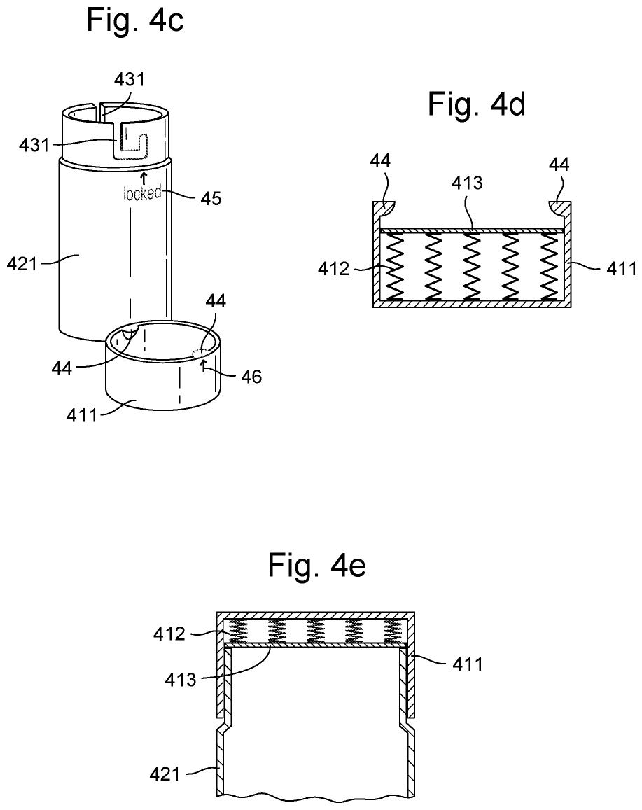

FIGS. 4a and 4b depict an alternative embodiment having grooves and notches. FIG. 4a depicts the lid (41) situated on the container (42) in a closed position. FIG. 4b depicts the lid (41) removed from the container (42); the lid (41) is in an inverted position. The container (42) comprises two grooves (43). The lid (41) comprises two notches (44) situated on the internal rim of the lid. The grooves (43) are wide enough for the notches (44) to pass through. The lid (41) and the container (42) comprise a marker (46 & 45 respectively) which when they are aligned, indicate that the lid (41) is in a child safe position. From a closed position, the lid (41) must be rotated horizontally relative to the container (42) in a clockwise direction (looking vertically down on the receptacle), then the lid (41) must be lifted vertically, to remove the lid (41) from the container (42). During this movement, the notches (44) travel along and then up the groove (43).

FIGS. 4c, 4d and 4e depict an alternative embodiment having grooves, notches and a spring. FIG. 4c depicts the lid (411) removed from the container (421); the lid (411) is in an inverted position. FIG. 4d depicts a cross section of the lid (411) in which the spring mechanism (412 & 413) is visible; the lid is inverted, and the spring is in an extended position. FIG. 4e depicts a cross section of the lid (411) on the container (421) wherein the spring mechanism (412 & 413) is in a compressed position. The container (421) comprises two grooves (431), the groves have an extra vertical section at the end of the grove, compared to FIG. 4b. The lid (411) comprises two notches (44) and a spring mechanism (412 & 413). The spring mechanism comprises a circular plate (413) on which the upper rim of the container (421) can press and springs (412) which resiliently compress under force. The spring mechanism (412 & 413) increases the force required to manipulate the lid (411) off container (421) and holds the lid (411) in the closed or ‘locked’ position. From a closed position, which is indicated by markers (45 & 46), the user must first press the lid (411) down to the position depicted in FIG. 4e, wherein the circular plate (413) engages with the top rim of the container (412). In this position the user is pressing against the force of the springs (412). Maintaining the pressure, the user must rotate the lid (411) horizontally relative to the container (421). Finally, the user can release the pressure and lift the lid (411) vertically off the container (421). During this movement the notches (44) move through the grooves (431).

b) A Latch Release Mechanism

A latch release mechanism comprises a tab on the vertical wall of the container which aligns with a hole in the vertical wall of the lid. The tab comprises a protruding section which fits within the hole in the vertical wall of the lid. In a closed position the protruding section of the tab extends into the hole in the vertical wall of the lid. An attempt to lift the lid vertically is impeded since the hole cannot pass the protruding section of the tab. The tab comprises a partially cut out section of the wall of the container which may be deformably pressed into to the main cavity of the container. This may be achieved by the user pressing the protruding section of the tab. By pressing the tab into the main cavity of the container, the protruding section of the tab is removed from the hole in the vertical wall of the lid, thereby allowing the lid to be removed from the container in a vertical movement.

The receptacle may comprise one latch release mechanism. Preferably the receptacle comprises two latch release mechanisms. Preferably these are located opposite each other on the circumference of the receptacle.

The tab may be any suitable shape to allow deformable movement into the cavity of the container for example an arch, a rectangle having three sides cut-out, etc. When pressure is removed, the tab should spring back to a position in which it is aligned with the wall of the container.

The hole in the vertical wall of the lid and the protruding section of the tab may be any suitable shape, e.g., circular, rectangular, square, flower, star, etc. Preferably the hole and the protruding section are the same shape, however this is not required; the protruding section could be in the shape of a flower, sitting in a round hole. Preferable the protruding section is a three dimensional shape, for example a hemisphere. It may be preferable that the protruding section is formed from paper pulp to allow moulding of a button shape.

In an alternative embodiment the lid may be an ‘inverted’ lid, with the vertical walls of the lid sitting inside the container. In such an embodiment the latch would be situated on the vertical walls of the container and the hole on the vertical wall of the container.

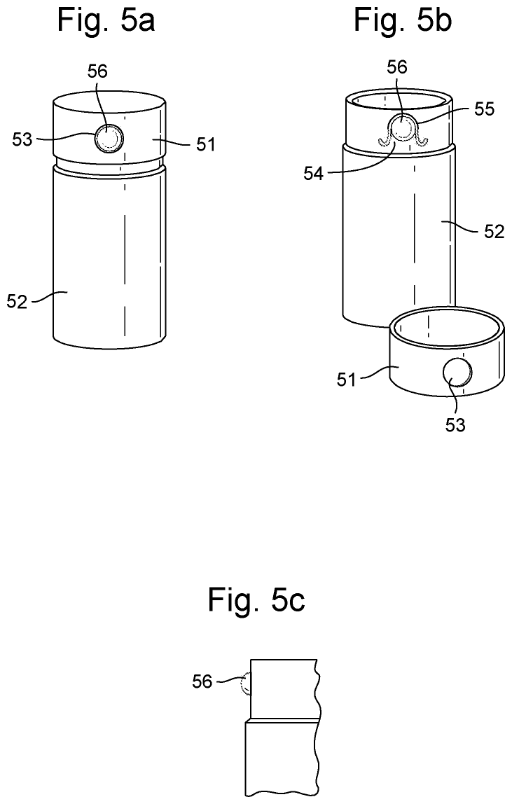

FIGS. 5a, 5b and 5c depict one possible embodiment. FIG. 5a depicts the lid (51) situated on the container (52) in a closed position. FIG. 5b depicts the lid (51) removed from the container (52); the lid (51) is in an inverted position. FIG. 5c depicts a cross-section of part of the container (52). The lid (51) comprises a hole (53) which is circular. The container (52) comprises tab (54) which is an arch shaped tab. Cut line (55) is a cut through the wall of container (52) which allows the tab to be pressed into the cavity of container (52). The tab comprises protruding section (56) which is in the shape of a hemisphere. In the closed position of FIG. 5a, the protruding section (56) protrudes from hole (53). To remove the lid (51) the user presses protruding section (56). This presses the tab (54) and protruding section (56) into the cavity of the container (52) and allows the lid (51) to move vertically upwards and off the container (52).

c) Alignable Holes

A rotating lid section with alignable holes comprises a mechanism in which the lid section is moveable relative to the container. For this mechanism, the lid and container both comprise a hole which are alignable, thereby forming an orifice through which the perfume particles may flow. The alignable holes may either be in the top face of the cylinder and top face of the lid or in the wall of the cylinder and the wall of the lid.

When the holes are in the top face of the cylinder and the top face of the lid, the lid maybe in the form of a disk or a cap. The disk or cap is rotatable relative to the container, when rotated to the correct orientation, the hole in the container and hole in the lid align. In this embodiment the lid section may be a plate or disk on the top face of the cylinder. The plate or disk may be the full diameter of the top face or may be smaller than the diameter of the top face. When the lid section is a disk or plate located on the top section of the cylinder, it may preferably comprise notches to aid in the rotation of the lid. Alternatively the lid section maybe a cap sitting over the top section of the cylinder. The cap comprising a top face and a vertical wall which extends vertically down the wall of the container. The vertical wall of the lid can be gripped to rotate the cap. The wall may preferably comprise notches to aid rotation.

When the holes are in the wall of the cylinder and wall of the lid, the lid may require rotation and/or movement around the vertical plane to align the holes. The lid may significantly overlap with the container, requiring it to be lifted vertically relative to the container thereby allowing the holes to align.

In either embodiment is preferable to have a stop mechanism to prevent the lid being removed from the container. This may for example be in the form of two ridges, one on the bottom inside edge of the lid and one on the top external edge of the container, wherein the ridges engage with each other when the lid reaches the furthest point of expansion, preventing further vertical movement of the lid relative to the container.

The lid may be an ‘over-cap’ wherein the vertical wall of the lid sits outside the container alternatively the lid may be an ‘inverted’ cap, wherein the vertical wall of the lid sits inside the container. The alignable holes can be implemented with either embodiment.

Most preferably the mechanism of alignable holes may be combined with an assembly of corresponding notches and ribs or groves or a latch release mechanism.

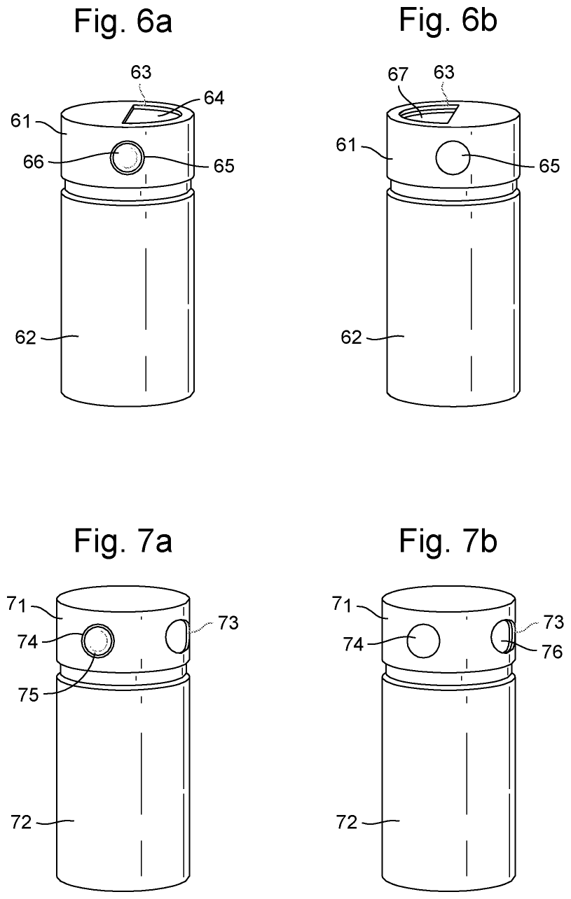

FIGS. 6a and 6b depict one possible embodiment in which the alignable holes mechanism and latch release mechanism are both employed. FIG. 6a depicts the lid (61) situated on the container (62) in a closed position. FIG. 6b depicts the lid (61) situated on the container (62) in an open position. The lid (61) comprises a hole in the top face (63) for the passage of perfume particles and a hole in the vertical wall (66) for the latch release mechanism. The container (62) comprises a top face (64), a hole in the top face (67) which is alignable by rotation with the hole in the top face of the lid (63) to allow the passage of perfume particles. The container also comprises a protruding section (66) which sits in the hole in the lid (65) for the latch release mechanism. In the closed position the protruding section (66) protrudes into the hole (65) thereby preventing movement of the lid (61) relative to the container (62). In use the consumer presses protruding section (66), which in turn presses a tab behind the protruding section (not shown) into the cavity of the container (62). With the protruding section and the tab pressed into the cavity of the container (62), the lid (61) is free to be rotated relative to the container (62). The lid (61) is rotated horizontally relative to the container (62) into the position depicted in FIG. 6b. The hole in the top face of the lid (63) aligns with hole in the top face of the container (67) and an orifice is formed, through which the perfume particles can flow. To close, the lid is rotated until the hole in the vertical wall (65) aligns with the protruding section (66), which springs back into the hole (65), thereby locking the lid (61) shut.

FIGS. 7a and 7b depict an alternative possible embodiment in which the alignable holes mechanism and latch release mechanism are both employed. FIG. 7a depicts the lid (71) situated on the container (72) in a closed position. FIG. 7b depicts the lid (71) situated on the container (72) in an open position. The lid (71) comprises a hole in the vertical wall (73) for the passage of perfume particles and a hole in the vertical wall (74) for the latch release mechanism. The container (72) comprises a hole in the vertical wall (76) which is alignable by rotation with the hole in the vertical wall of the lid (73) to allow the passage of perfume particles and a protruding section (75) which sits in the hole in the lid (74) for the latch release mechanism. In the closed position, protruding section (75) protrudes into the hole (74) thereby preventing movement of the lid (71) relative to the container (72). In use the consumer presses protruding section (75), which in turn presses a tab behind the protruding section (not shown) into the cavity of the container (72). With the protruding section and the tab pressed into the cavity of the container (72), the lid (71) is free to be rotated relative to the container (72). The lid (71) is rotated into the position depicted in FIG. 7b. The hole in the vertical wall of the lid (73) aligns with the hole in the vertical wall of the container (76) and an orifice is formed, through which the perfume particles can flow. To close, the lid is rotated until the hole in the vertical wall (74) aligns with the protruding section (75), which springs back into the hole (74), thereby locking the lid (71) shut.

d) A Deformable Lid

A deformable lid mechanism employs the use of a deformable section in the lid. The lid may be compressible along the horizontal plane, or may be bendable into a concave or convex shape. The result of having a deformable section, is that when pressure is exerted on the lid, in the correct direction, the diameter of the lid reduces, allowing it to be removed from the container. The compressibility may simply be achieved by using a thin sheet of material comprising cellulosic fibres, alternatively it may be achieved, by pre-scored fold lines which, when pressure is exerted, fold in, allowing a reduction in diameter. Preferably the lid and container have a securing means such as a hook on the lid, which engages with a lip on the container, preventing the vertical removal of the lid, without the compression of the lid.

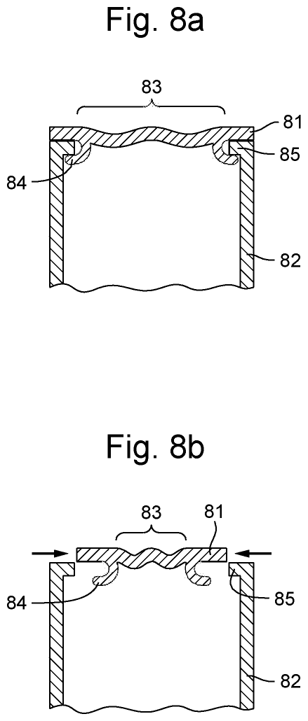

FIGS. 8a and 8b depict one possible embodiment with a deformable lid. FIG. 8a depicts the lid (81) engaged with container (82) in a closed position. FIG. 8b depicts the lid (81) in a compressed position in which the lid (81) has a reduced diameter, and can be removed from the container (82). The lid (81) comprises compressible section (83) and hooks (84). The container (82) comprises lip (85). In a closed position, no pressure is exerted on compressible section (83). The hooks (84) engage with lip (85), thereby preventing the lid (81) from being lifted vertically off the container (82). To release the lid, horizontal pressure is exerted as demonstrated by the arrows on FIG. 8b, the pressure leads to compression of section (83). Compression of section (83) reduces the diameter of the lid (81) this moves the hooks (84) horizontally away from lip (85), allowing the lid (81) to be lifted from the container (82).

e) An External Securing Mechanism

An external securing mechanism employs the use of an additional component to secure the lid to the container. This may be by means of a clip or catch. Alternatively, this may be by means of a pin which is inserted through the cross section of the cylinder, penetrating the lid and container on both sides of the receptacle. This requires that the lid and container overlap and have corresponding holes which meet and allow the pin to pass through the whole cross-section of the cylinder.

When an external securing mechanism is used, this does not contribute to the overall weight of the receptacle for the purposes of calculating the weight % of perfume barrier material present.

When an external securing mechanism is used, it is preferably removable, allowing the receptacle to be recycled without the securing mechanism attached.

The securing mechanism may be formed of plastic, wood, meatal or any such suitable material. The securing mechanism may preferably be re-usable, so that it may be reused with the next purchase of a packaged laundry product described herein.

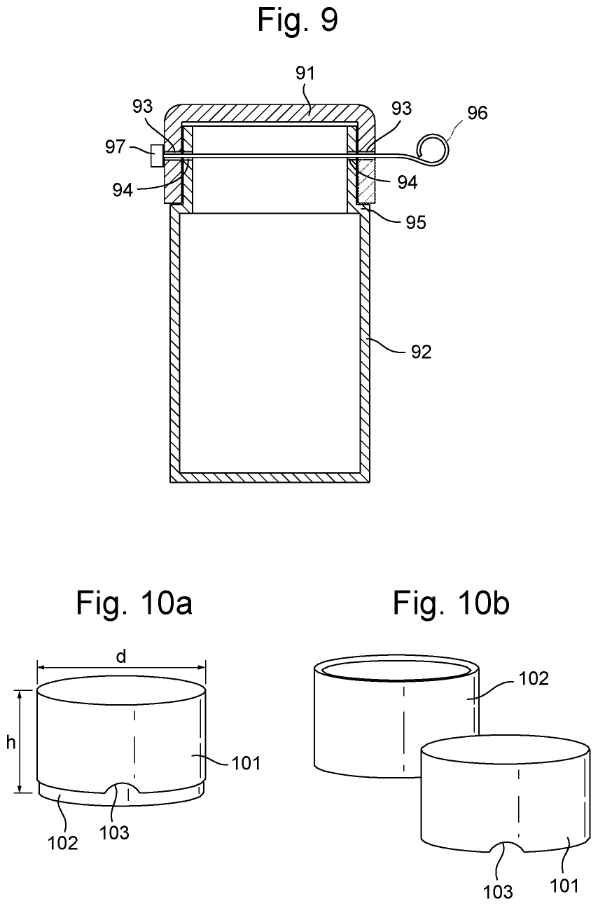

FIG. 9 depicts one possible embodiment in which an external securing means is employed. FIG. 9 is a cross section depicting the lid (91) situated on the container (92) in a closed position, with a pin (96) securing the lid shut. The lid comprises two channels (93) which are directly opposite on the circumference of the lid (91) and are wide enough for pin (96) to pass through. The container comprises two holes (94) which are directly opposite on the circumference of the container (92) and are wide enough for pin (96) to pass through, and shoulder (95) on which the lid (91) rests. The channels (93) and holes (94) align when the lid (91) sits on shoulder (95). The when the channels (93) and holes (94) are aligned, the pin (96) can pass through the channels (93) and holes (94). Securing means (97) attaches to the end of the pin (96), preventing the pin from being pulled back through the channels (93) and holes (94). In this embodiment the securing means (97) is screwed onto the pin (96) (not shown). In use, the securing means (97) is removed from pin (96), the pin (96) is pull out of the channels (93) and holes (94) and the lid (91) is removed from container (92).

f) Friction Fit Interaction Between Lid and Container

Friction fit interaction between a lid and a container occurs when the fiction is minimised, thereby forming an airlock within the container which in turn increased the force required to separate the lid and container.

When a friction fit mechanism is employed, it is preferable to maximise the surface interaction between the lid and the box. The height of the lid compared to the height of the container is preferably in a ratio of at least 1:3. For example is the container has a height of 18 cm, the lid preferably has a height of at least 6 cm. More preferably the ratio of lid height to container height is at least 1:2, more preferably at least 2:3.

When a friction fit mechanism is employed, preferably the diameter of the lid (the widest diameter for an elliptical cylinder) is greater than the height of the container. Having a wider diameter, further impedes child access.

When a friction fit mechanism is employed, preferably the lid will have notches or cut out sections to grip when removing the lid.

When a friction fit mechanism is employed, preferably the material comprising cellulosic fibres has a friction coefficient of less than 0.3, more preferably less than 0.2, most preferably less than 0.15 as measured according to ASTM D 1894.

The lid may be an ‘over-cap’ wherein the vertical wall of the lid sits outside the container alternatively the lid may be an ‘inverted’ cap, wherein the vertical wall of the lid sits inside the container. A friction fit mechanism can be implemented with either embodiment.

FIGS. 10a and 10b depict one possible embodiment. FIG. 10a depicts the lid (101) situated on container (102). FIG. 10b depicts the lid (101) removed from container (102). The diameter of the lid (d) is greater than the height of the container (h). The height of the lid (not shown) compared to the height of the container (h) is at least 2:3 as a ratio. The lid (101) has notches (103) to aid removal of the lid (101) from the container (102). The lid (101) is removed from the container (102) by holding the notches (103) and pulling vertically relative to the container (102).

g) A Multi Rotation Screw Mechanism

A multi rotation screw mechanism comprises a screw thread between the lid and the container, wherein more than one full rotation of the lid is required to remove the lid from the container i.e. at least a 360° rotation of the lid is required to release the lid from the screw thread. Preferably at least two full rotations of the lid are required and most preferably at least three full rotations of the lid are required.

The lid may be an ‘over-cap’ wherein the vertical wall of the lid sits outside the container alternatively the lid may be an ‘inverted’ cap, wherein the vertical wall of the lid sits inside the container. A multi rotation screw mechanism can be implemented with either embodiment.

When a multi rotation screw mechanism is employed, preferably the diameter of the cylinder (the widest diameter for an elliptical cylinder) is greater than the height of the cylinder. Having a wider diameter further impedes child access.

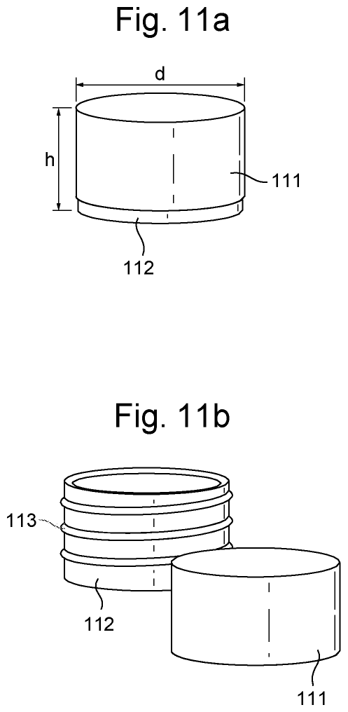

FIGS. 11a and 11b depict one possible embodiment. FIG. 11a depicts the lid (111) situated on container (112). FIG. 11b depicts the lid (111) removed from container (112). The diameter of the lid (d) is greater than the height of the container (h). The container (103) has screw threads (113) and the lid (111) has corresponding threads (not shown). The lid (111) is removed from the container (112) by rotating/‘screwing’ the lid (111) in a horizontal direction relative to the container (112). Three rotations are required to remove the lid (111) from the container (112).

a) Expandable Pack

An expandable pack mechanism allows the pack to expand, thereby revealing a hole through which perfume particles can flow. The expanding mechanism may be provided by a telescopic section of the pack. As an example the vertical walls of the lid may sit inside the container and extend almost the full depth of the container. When the lid and the container are pulled apart, either by pulling the container down or the lid up, the vertical walls of the lid slide out of the container revealing a hole in the vertical wall of the container. Alternatively the vertical walls of the container may sit inside the vertical walls of the lid. When the lid and the container are pulled apart, either by pulling the container down or the lid up, the vertical walls of the container slide out of the lid revealing a hole in the vertical wall of the container.

Preferably the lid and container comprise a mechanism which stops extension past a certain point. In a simple form, this could be formed by a lip around the circumference of the lid and a corresponding lip around the circumference of the container, the lips abutting and preventing further extension when a certain level of extension is reached. If the lid were sitting inside the container, the lips may be positioned on the outside rim of the lid and the inside rim of the container. The lip may suitably be provided by a shoulder on the container.

The hole may be any suitable shape, for example, round, oval, square, rectangular, semi-circle etc.

The expandable pack mechanism may preferable be used in combination with other mechanisms described herein.

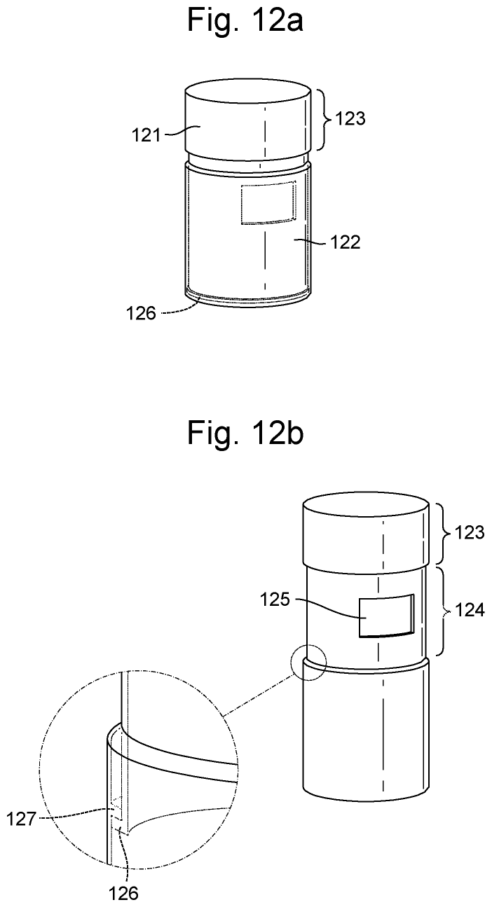

FIGS. 12a and 12b depict one possible embodiment. FIG. 12a depicts the lid (121) and container (122) in a closed position. FIG. 12b depicts the lid (121) and container (122) in an open position. The lid (121) comprises a top section (123) which appears to be a traditional lid and a bottom section (124) which in a closed position is nested inside the container (122). At the bottom of the bottom section (124), on the external rim is a lip (126) running around the circumference. The lid (121) also comprises a hole (125) which is hidden when in a closed position; in an open position the hole (125) is revealed and forms an orifice through which perfume particles can flow. The container (122) comprises a lip (127) on the upper internal vertical wall. In use the lid (121) and container (122) are pulled apart vertically and the telescopic or bottom section of the lid (124) and the hole (125) are revealed. The lips (126) and (127) abut, preventing the lid (121) from being separated from the container (122).

Other suitable child impeding closure mechanisms may also be employed.

Preferably the receptacle comprises a mechanism selected from: an assembly of corresponding notches and ribs or groves in the lid and container, latch release mechanism, alignable holes mechanism, deformable lid mechanism, an external securing mechanism, friction fit interaction between lid and container mechanism, multi rotation screw mechanism, expandable pack mechanism and combinations thereof.

More preferably, the receptacle comprises a mechanism selected from: an assembly of corresponding notches and ribs or groves in the lid and container, latch release mechanism, alignable holes mechanism, an external securing mechanism, expandable pack mechanism and combinations thereof.

Most preferably, the receptacle comprises a mechanism selected from an assembly of corresponding notches and ribs or groves in the lid and container, latch release mechanism, alignable holes mechanism, expandable pack mechanism and combinations thereof.

Preferably the mechanism is formed from formed from a material comprising cellulosic fibres, as described above.

The receptacle may be printed on using conventional inks. The printing may occur before or after the formation of the container and lid.

The receptable my preferably comprise a perfume barrier layer. When present, the perfume barrier constitutes 1 to 5 wt. % of the packaging, preferably 1.5 to 4 wt. % of the packaging. When the perfume barrier is present in a level of 1 to 5 wt. % of the total packaging, this provides a significant reduction in perfume leakage so that the consumer receives a ‘hit’ of perfume when opening the receptacle, while maintaining the recyclability of the receptacle.

The perfume barrier is either coated on the material comprising cellulosic fibres or incorporated into the material comprising cellulosic fibres. The perfume barrier may generally fall into the category of a foil, film or wax which coats or is incorporated into the material comprising cellulosic fibres. Preferably the perfume barrier layer is coated on the entire internal and/or external surface of the receptacle or alternatively incorporated into all parts of the material comprising cellulosic fibres used to manufacture the receptacle, i.e. the lid and container. Most preferably the perfume barrier layer is coated on the entire internal and/or external surface of the receptacle.

The perfume barrier material may preferably be selected from the group consisting of a polyglycolic acid (PGA), pofyolefin (e.g., polyethylene, polypropylene), polyvinylidene chloride, polyvinyl alcohol, polyvinyl acetate, nanoclay (e.g. montmorillonites, vermiculite platelets), graphene, graphene oxide, calcium carbonate, wax, varnish, aluminium foil, metal, metal oxides and mixtures thereof. More preferably the perfume barrier material is selected from polyolefins, polyvinyl alcohols, poly acetates, waxes and mixtures thereof.

As used herein, the term “polyolefin” refers to a virgin, petroleum-based polyolefin, consumer recycled polyolefin, industrial recycled polyolefin, polyolefin derived from a renewable resource (i.e., produced by a natural process at a rate comparable to its rate of consumption, such as plants, animals, fish, bacterial, fungi, and forestry products), or a mixture thereof.

Specific examples of suitable preferred perfume barrier materials include: ethylene vinyl alcohol co-polymer (EVOHs), polyethylene (PE), polyethylene terephthalate (PET), polypropolyene, polypropylene (PP), polyester, polyamides; ethylene vinyl acetate; ethylene acrylic acid; polystyrene, polycarbonate, Polyhydroxyalkanoates (PHAs) and mixtures thereof. These polymers may be produced from virgin, recycled or renewable sources.

Preferably the perfume barrier comprises recycled material. More preferably the perfume barrier consists of recycled material.

It may be preferable to apply a primer to the surface of the paper board before applying the perfume barrier layer.

Perfume Particles

The perfume particles described herein comprise a carrier material and perfume components. The particles may preferably comprise additional fabric benefit agents.

The carrier material, i.e. the material which constitutes the majority of the perfume particle is a solid. The perfume particles described herein comprise at least 50 wt. % carrier materials, preferably 65 wt. %, more preferably 80 wt. % and most preferably at least 90 wt. % carrier materials, by weight of the perfume particle. Preferably the perfume particles comprise less than 98 wt. % carrier material.

The carrier material may be any material which disperses, dissolves, disintegrates or solubilises in water. The perfume particle my comprise one carrier material or a combination of different carrier materials.

The carrier material may be selected from the group consisting of: synthetic polymers (e g, polyethylene glycol, ethylene oxide/propylene oxide block copolymers, polyvinyl alcohol, polyvinyl acetate, and derivatives thereof), proteins (e.g., gelatin, albumin, casein), saccharides (e.g. dextrose, fructose, galactose, glucose, isoglucose, sucrose), polysaccharides (e.g., starch, xanthan gum, cellulose, or derivatives thereof), water-soluble or water dispersible fillers (e.g. sodium chloride, sodium sulfate, sodium carbonate/bicarbonate, zeolite, silica, clay), vegetable soap (e.g. coconut soap beads or palm soap), ethoxylated non-ionic surfactants (having a formula R₁O(R₂O)xH, wherein R₁ preferably comprises 12 to 20 carbon atoms, R₂ is C₂H₄ or mixture of C₂H₄ and C₃H₆ units and x=8 to 120) and combinations thereof.

Examples of suitable carrier materials include: water soluble organic alkali metal salt, water soluble inorganic alkaline earth metal salt, water soluble organic alkaline earth metal salt, water soluble carbohydrate, water soluble silicate, water soluble urea, starch, xanthan gum, dextrose, clay, water insoluble silicate, citric acid carboxymethyl cellulose, fatty acid, fatty alcohol, glyceryl diester of hydrogenated tallow, glycerol, polyvinyl alcohol, non-ionic surfactants sold under the trade name Lutensol ex. BASF and combinations thereof.

Preferred carrier materials may be selected from the group consisting of synthetic polymers (e g, polyethylene glycol, ethylene oxide/propylene oxide block copolymers, polyvinyl alcohol, polyvinyl acetate, and derivatives thereof), polysaccharides (e.g., starch, xanthan gum, cellulose, or derivatives thereof), saccharides (e.g., dextrose, fructose, galactose, glucose, isoglucose, sucrose), vegetable soap (e.g. coconut soap beads or palm soap), ethoxylated non-ionic surfactants (having a formula R₁O(R₂O)xH, wherein R₁ preferably comprises 12 to 20 carbon atoms, R₂ is C₂H₄ or mixture of C₂H₄ and C₃H₆ units and x=8 to 120) and combinations thereof.

More preferably the carrier is selected from polyethylene glycol, starch, dextrose, coconut soap beads, palm soap, non-ionic surfactants and combinations thereof.

Polyethylene glycol comes in various weight average molecular weights. A suitable weight average molecular weight of PEG for the purposes of the present invention includes from 4,000 to 12,000, preferably 5,000 to 11,000, more preferably 6,000 to 10,000 and most preferably 7,000 to 9,000. Non-limiting examples of suitable PEG is are: Polyglycol 8000 ex Clariant and Pluriol 8000 ex BASF.

Saccharides are molecular compounds comprising carbon, hydrogen and oxygen. For the purposes of this invention a saccharide is defined as comprising one to ten monosaccharide units and mixtures thereof. In other words either a monosaccharide or an oligosaccharide or mixtures thereof. An oligosaccharide is a short saccharide polymer, typically considered in the art to comprise between two and ten monosaccharides units. It is preferred that a saccharide comprises 1 to 5 monosaccharide units, more preferably 1 to 4 monosaccharide units, most preferably the saccharide comprises monosaccharides, disaccharides or mixtures thereof. Disaccharides are the product of a reaction between two monosaccharides. They may be formed from two identical monosaccharides or two different monosaccharides. Examples of disaccharides include: sucrose, maltose, lactose. Monosaccharides are simple sugar units having the general formula (CH₂O)ₙ. Commonly n is 3, 5 or 6. According, monosaccharides can be classified by the number n, for example: trioses (e.g. glyceraldehyde), pentoses (e.g. ribose) and hexoses (e.g. fructose, glucose and galactose). Some monosaccharides may be substituted with additional functional groups, e.g. Glucosamine, others may have undergone deoxgenation and lost an oxygen atom e.g. deoxyribose. Therefore, the general chemical formulae can vary slightly depending on the monosaccharide.

Preferred monosaccharides for the present invention are hexose molecules (n=6). Hexose molecules all have the same molecular formula, however, have a different structural formula, i.e. are structural isomers. It is preferred that the hexose comprises a 6-membered ring, opposed to a 5 membered ring. Glucose and galactose have 6-membered rings. In a preferred embodiment the hexose monosaccharide is glucose. Glucose is a chiral molecule, having a mixture of D and L stereo isomers. Particularly preferably, the glucose of the present invention is the D isomer of glucose, also known as dextrose.

Preferably a saccharide material used in the present invention is anhydrous, i.e. free of any water. For example, dextrose monohydrate contains one molecule of water whereas anhydrous dextrose contains none.

Non-limiting examples of suitable saccharides for the present invention are: C*Dex ex Cargill, Treha ex Cargill, Anhydrous Dextrose ex Foodchem.

When a saccharide is used in the present invention, it may be preferable to include bitter material such as Bitrex ex Johnson Matthey Fine Chemicals, due to the sweetness of the saccharide.

Preferred ethoxylated non-ionic surfactants have a general formula RO(C₂H₄O)xH, wherein R is a saturated alcohol having a carbon chain of C12 to C20 and wherein x is 8 to 120, preferably 25 to 90 and most preferably 45 to 85.

The perfume particles of the present invention comprise 0.5 to 20 wt. % perfume components. Perfume components may comprise free oil perfume, perfume microcapsules or combinations thereof.

Preferably the perfume particles of the present invention comprise 1 to 20 wt. % perfume components, more preferably 2 to 15 wt. % components, most preferably 4 to 10 wt. % perfume components. By perfume components it is meant the combined free perfume and any encapsulated perfume.

The perfume particles of the present invention may comprise one or more perfume compositions. The perfume compositions may be in the form of a mixture of free perfume compositions or a mixture of encapsulated and free oil perfume compositions.

Useful perfume components may include materials of both natural and synthetic origin. They include single compounds and mixtures. Specific examples of such components may be found in the current literature, e.g., in Fenaroli's Handbook of Flavor Ingredients, 1975, CRC Press; Synthetic Food Adjuncts, 1947 by M. B. Jacobs, edited by Van Nostrand; or Perfume and Flavor Chemicals by S. Arctander 1969, Montclair, N.J. (USA). These substances are well known to the person skilled in the art of perfuming, flavouring, and/or aromatizing consumer products.

Particularly preferred perfume components are blooming perfume components and substantive perfume components. Blooming perfume components are defined by a boiling point less than 250° C. and a LogP greater than 2.5. Substantive perfume components are defined by a boiling point greater than 250° C. and a LogP greater than 2.5. Preferably a perfume composition will comprise a mixture of blooming and substantive perfume components. The perfume composition may comprise other perfume components.

It is commonplace for a plurality of perfume components to be present in a perfume composition. In the compositions for use in the present invention it is envisaged that there will be three or more, preferably four or more, more preferably five or more, most preferably six or more different perfume components. An upper limit of 300 perfume ingredients may be applied.

Free perfume may preferably be present in an amount from 0.01 to 20 wt. %, more preferably 0.1 to 15 wt. %, more preferably from 0.1 to 10 wt. %, even more preferably from 0.1 to 6.0 wt. %, most preferably from 0.5 to 6.0 wt. %, based on the total weight of the perfume particles.

Preferably some of the perfume components are contained in a microcapsule. Suitable encapsulating materials may comprise, but are not limited to; aminoplasts, proteins, polyurethanes, polyacrylates, polymethacrylates, polysaccharides, polyamides, polyolefins, gums, silicones, lipids, modified cellulose, polyphosphate, polystyrene, polyesters or combinations thereof.

Perfume components contained in a microcapsule may comprise odiferous materials and/or pro-fragrance materials.

Particularly preferred perfume components contained in a microcapsule are blooming perfume components and substantive perfume components. Blooming perfume components are defined by a boiling point less than 250° C. and a LogP greater than 2.5. Substantive perfume components are defined by a boiling point greater than 250° C. and a LogP greater than 2.5. Preferably a perfume composition will comprise a mixture of blooming and substantive perfume components. The perfume composition may comprise other perfume components.

It is commonplace for a plurality of perfume components to be present in a microcapsule. In the compositions for use in the present invention it is envisaged that there will be three or more, preferably four or more, more preferably five or more, most preferably six or more different perfume components in a microcapsule. An upper limit of 300 perfume ingredients may be applied.

Encapsulated perfume may preferably be present in an amount from 0.01 to 20 wt. %, more preferably 0.1 to wt. 15%, more preferably from 0.1 to 10 wt. %, even more preferably from 0.1 to 6.0 wt. %, most preferably from 0.5 to 6.0 wt. %, based on the total weight of the perfume particles.

The perfume particles of the present invention preferably comprise a colourant. The colourant may be a dye or a pigment or a mixture thereof. The colourant has the purpose to impart colour to the composition, it is not intended to be a shading dye or to impart colour to the laundered fabrics. A single colourant or a mixture of colourants may be used.

Preferably, the colourant is a dye, more preferably a polymeric dye. Non-limiting examples of suitable dyes include the LIQUITINET range of dyes ex Milliken Chemical.

Preferably the perfume particles of the present invention comprise 0.001 to 2 wt. %, more preferably 0.005 to 1 wt. %, most preferably 0.01 to 0.6 wt. % colourant.

The perfume particles of the present invention may contain further optional laundry ingredients. Such ingredients include preservatives, pH buffering agents, perfume carriers, hydrotropes, polyelectrolytes, anti-shrinking agents, anti-oxidants, anti-corrosion agents, drape imparting agents, anti-static agents, ironing aids, anti-wrinkle agents, antifoams, pearlisers and/or opacifiers, natural oils/extracts, processing aids, e.g. electrolytes, anti-malodour agents, hygiene agents, e.g. anti-bacteria's, antifungals, anti-virals, low levels of cationic surfactants such as quaternary ammonium compounds and skin benefit agents.

The perfume particles may be in any particulate form, for example: powder, pellet, tablet, prill, pastille or extrudate. Preferably the perfume particles are in the form of a pastille or extrudate. Pastilles can, for example, be produced using ROTOFORMER Granulation Systems ex. Sandvick Materials.

The perfume particles of the present invention may be formed from a melt. The solid composition can for example, be formed into particles by: Pastillation e.g. using a ROTOFORMER ex Sandvick Materials, extrusion, prilling, by using moulds, casting the melt and cutting to size or spraying the melt.

An example manufacturing process may involve melting the carrier material at a temperature above the melting point of the carrier material, preferably at least 2° C. above the melting point of the carrier material, more preferably at least 5° C. above the melting point of the carrier material. Where more than one carrier materials are used, the melting point is considered to be the highest of the melting points of the individual materials. Once melted, the perfume and other ingredients may be mixed into the compositions. This is followed by a process in which the melt in cooled and shaped, e.g. extrusion or pastillation.

The perfume particles of the present invention are preferably homogeneously structured. By homogeneous, it is meant that there is a continuous phase throughout the solid product. There is not a core and shell type structure. Any particles present, such as perfume microcapsules will be distributed within the continuous phase. The continuous phase is provided predominately by the carrier materials.

The perfume particles may be any shape or size suitable for dissolution in the laundry process. Preferably, each individual particle of the solid composition has a mass of between 0.95 mg to 5 grams, more preferably 0.01 to 1 gram and most preferably 0.02 to 0.5 grams. Preferably each individual particle has a maximum linear dimension in any direction of 1-10 mm, more preferably 2-8 mm and most preferably a maximum linear dimension of 4-6 mm i.e. the maximum dimension in any direction is between the ranges disclosed herein. The shape of the particles may be selected for example from spherical, hemispherical, compressed hemispherical, lentil shaped, oblong, or planar shapes such as petals. A preferred shape for the particles is hemispherical, i.e. a dome shaped wherein the height of the dome is less than the radius of the base. When the particles are compressed hemispherical, it is preferred that diameter of the substantially flat base provides the maximum linear dimension and the height of the particle is 1-5 mm, more preferably 2-3 mm. The dimensions of the particles of the present invention can be measured using Calipers.

The perfume particles may be added to the laundry process in either the wash or the rinse phase of the laundry process.

In one aspect of the present invention is provided a method of storing perfume particles as described herein, in packaging as described herein.

In another aspect of the present invention is provided use of packaging as described herein to contain perfume particles as described herein.

### EXAMPLES

TABLE 1
Example composition of perfume particles

Inclusion % by weight

| Ingredient | 3 | 4 |
|---|---|---|
| PEG 8000 ¹ | 70 | 91.09 |
| Starch ² | 20 | — |
| Blue dye ³ | — | 0.01 |
| Free perfume | 7 | 5 |
| Perfume microcapsules | — | 2 |

PEG 8000 ¹—Polyglycol 8000 ex Clariant
Starch ²—Tapioca C*Creamgel 7001 ex Cargill
Blue dye ³—Milliken Liquitint Blue HP

1. A packaged laundry product comprising packaging and perfume particles contained in said packaging;
wherein the packaging comprises a cylindrical receptacle formed from a material comprising cellulosic fibres, wherein the receptacle comprises a mechanism for impeding a child's access to the container;
and wherein the perfume particles comprise carrier material and 0.5 to 20 wt. % perfume components;
wherein the mechanism for impeding a child's access to the container is formed from a material comprising cellulosic fibres.

2. The packaged laundry product according to claim 1, wherein the receptacle is formed from cardboard, paper pulp, other cellulosic materials, or a combination thereof.

3. The packaged laundry product according to claim 1, wherein the mechanism for impeding a child's access to the container is selected from: an assembly of corresponding notches and ribs or groves in the lid and container, latch release mechanism, alignable holes mechanism, deformable lid mechanism, an external securing mechanism, friction fit interaction between lid and container mechanism, multi rotation screw mechanism, expandable pack mechanism and combinations thereof.

4. (canceled)

5. The packaged laundry product according to claim 1, wherein the packaging comprises a perfume barrier layer which is either coated on the material comprising cellulosic fibres or incorporated into the material comprising cellulosic fibres.

6. The packaged laundry product according to claim 5, wherein the perfume barrier layer is selected from: polyglycolic acid (PGA), polyolefin, polyvinylidene chloride, polyvinyl alcohol, polyvinyl acetate, nanoclay, graphene, graphene oxide, calcium carbonate, wax, varnish, aluminium foil, metal, metal oxides and mixtures thereof, Preferably the perfume barrier material is selected from polyolefins, polyvinyl alcohols, poly acetates, waxes and mixtures thereof.

7. The packaged laundry product according to claim 1, wherein the perfume particles comprise at least 50 wt. % carrier material.

8. The packaged laundry product according to claim 1, wherein the carrier material is selected from: synthetic polymers, proteins, saccharides, polysaccharides, water-soluble or water dispersible fillers, vegetable soap, ethoxylated non-ionic surfactants and combinations thereof.

9. The packaged laundry product according to claim 1, wherein the perfume components comprise free perfume.

10. The packaged laundry product according to claim 1, wherein the perfume components comprise encapsulated perfume.

11. The packaged laundry product according to claim 9, wherein the perfume particles comprise 0.01 to 20 wt. % encapsulated perfume.

12. The packaged laundry product according to claim 1, wherein the perfume particles have a maximum liner dimension of 1 to 10 mm.

13. A The packaged laundry product according to claim 1, wherein the perfume particles are in the form of a pastille or extrudate.

14. A method of storing perfume particles, wherein perfume particles comprising a carrier and perfume components are contained in packaging comprising a cylindrical receptacle formed from a material comprising cellulosic fibres, wherein the receptacle comprises a mechanism for impeding a child's access to the container; wherein the perfume particles comprise carrier material and 0.5 to 20 wt. % perfume components; and wherein the mechanism for impeding a child's access to the container is formed from a material comprising cellulosic fibres.

15. The packaged laundry product according to claim 6 wherein the polyolefin is polyethylene or polypropylene and the nanoclay is montmorillonite or vermiculite platelet.
